(19) United States
(12) Patent Application Publication
(10) Pub. No.: US 2016/0378265 A1
(43) Pub. Date: Dec. 29, 2016

(54) POSITION DETECTING DEVICE

(71) Applicant: Wacom Co., Ltd., Saitama (JP)

(72) Inventors: Yuji Katsurahira, Saitama (JP); Katsu Chao, Saitama (JP)

(21) Appl. No.: 15/262,819

(22) Filed: Sep. 12, 2016

Related U.S. Application Data
(63) Continuation of application No. PCT/JP2015/054209, filed on Feb. 17, 2015.

(30) Foreign Application Priority Data
Mar. 17, 2014 (JP) 2014-053505
Apr. 18, 2014 (JP) 2014-086269

(51) Int. Cl. G06F 3/041; G02F 1/1333; G06F 3/0354; G06F 3/038; G06F 3/044; G06F 3/046

(52) U.S. Cl. CPC G06F 3/0418; G06F 3/044; G06F 3/0412; G06F 3/046; G06F 3/03545; G06F 3/0383; G02F 1/13338; G06F 2203/04102; G06F 2203/04104; G06F 2203/04106; G06F 2203/04107; G02F 1/1368

(57) ABSTRACT

A position detecting device detects a position indicated by a finger or a stylus over a display device. The position detecting device includes a noise sensor, which, in operation, generates indications of noise, and a noise detecting circuit, which, in operation, outputs noise detection signals based on indications of noise generated by the noise sensor. The position detecting device includes a pulse generating circuit, which, in operation, generates pulses having a periodic cycle based on a periodic cycle of a synchronizing pulse of the display device, and phase control circuitry, which, in operation, controls a phase of the pulses generated by the pulse generating circuit to synchronize timing of the output of noise detection signals by the noise detecting circuit with timing of the pulses generated by the pulse generating circuit. A receiving circuit of the position control device, in operation, receives position signals in synchronization with the timing of the pulses generated by the pulse generating circuit.

### TECHNICAL FIELD

The present disclosure relates to a transparent position detecting device that is disposed over the front surface of a display device and to which input by a finger or a stylus can be made.

### BACKGROUND ART

In recent years, tablet information terminals equipped with a touch panel have come to be frequently used. Among devices of this kind are ones that allow input by a stylus for easy execution of handwriting character input and drawing of a picture, an illustration, and so forth, which are difficult with a finger. As a pen input technique for this purpose, a method disclosed in patent document 1 has been widely used.

According to the method of patent document 1 (Japanese Patent Laid-Open No. Sho 63-70326), a position indicator that is a stylus is provided with a resonant circuit, and an indicated position is detected by electromagnetic induction with a tablet. However, a sensor plate configuring the tablet needs to be provided under the back surface of a display device. This causes problems that the structure of the device becomes complicated because a certain level of current needs to be made to flow through loop coils configuring the sensor plate and that the position detection is susceptible to the influence of noise from the display device and the coordinate position cannot be reliably detected.

According to the position input device and computer system disclosed in patent document 2 (Japanese Patent Laid-Open No. 2007-164356) by the same applicant as patent document 1, making a tablet sensor transparent and disposing the tablet sensor over the whole surface of a display device are enabled by equipping a stylus with an electrical double-layer capacitor. However, in the disclosure of this patent document 2, the fact remains that the position detection is affected by noise emitted by the display device, and the coordinate position cannot be disclosure of obtained.

In patent document 3 (JP-T-2005-537570), a transparent digitizer is disclosed that obtains the position indicated by a stylus by signals from differential amplifiers arranged in association with the respective electrodes of a transparent sensor disposed over a display device. According to the transparent digitizer of this patent document 3, two electrodes are simultaneously selected from the transparent sensor to detect the difference in the signal. Thus, the position detection is less susceptible to the influence of external noise.

Furthermore, in patent document 4 (Japanese Patent Laid-Open No. Hei 6-337752), a coordinate detecting device is disclosed that is provided with an analog multiplexer to select two electrode lines from electrode lines of a tablet and differentially amplifies signals from the two electrode lines selected by the analog multiplexer to exclude the influence of external noise.

### PATENT DOCUMENTS

Patent Document 1: Japanese Patent Laid-Open No. Sho 63-70326

Patent Document 2: Japanese Patent Laid-Open No. 2007-164356

Patent Document 3: JP-T-2005-537570

Patent Document 4: Japanese Patent Laid-Open No. Hei 6-337752

### SUMMARY

### Technical Problem

In an input device that is integrated with a display device and is transparent, the resistance value of an electrically-conductive material forming the electrodes is high and the display device itself generates strong noise. Thus, it is difficult to reliably obtain the coordinate position of a stylus.

In the disclosure of patent document 3 and patent document 4, to solve this problem, external noise is canceled by simultaneously selecting two electrodes and detecting the difference in the signal by using the differential amplifier.

However, the noise generated by the display device such as a liquid crystal panel is extremely strong compared with a signal transmitted from the stylus. Therefore, it is difficult to sufficiently exclude the influence of the noise by only using the differential amplifier.

An embodiment provides a position detecting device that facilitates accurately detecting and inputting the coordinate position of a finger or a stylus by using a transparent sensor disposed integrally with a display device without being affected by noise emitted by the display device.

### Technical Solution

In an embodiment, a position detecting device detects a position indicated by a finger or a stylus over a display device capable of refreshing displaying at a periodic cycle. In an embodiment, the position detecting device includes a noise detecting circuit that is provided with a noise sensor to detect noise around the display device or around a drive circuit of the display device and outputs noise detection information when noise detected by the noise sensor is equal to or higher than a determined level. The position detecting device includes a pulse generating circuit that generates a pulse at the same periodic cycle as a periodic cycle of a synchronizing pulse of the display device. Phase control circuitry in the position detecting device controls a phase of the pulses generated by the pulse generating circuit to synchronize a timing of the noise detection signals with a timing of the pulses generated by the pulse generating circuit. In an embodiment, the phase control circuitry controls the phase of the pulses generated by the pulse generating circuit to maintain a rate of occurrence of synchronization of the noise detection signals output by the noise detecting circuit with the pulses generated by the pulse generating circuit, which is equal to or higher than a threshold value. The position detection device includes a receiving circuit that receives a signal by the finger or the stylus in synchronization with the timing of the pulse output by the pulse generating circuit.

In an embodiment, the phase control circuitry is configured to output a control signal to cause a positive time shift in the pulse when a timing at which the noise detection information from the noise detecting circuit is output appears earlier than the timing of the pulse output by the pulse generating circuit by a difference within a threshold time, and output a control signal to cause a negative time shift when the timing at which the noise detection information from the noise detecting circuit is output appears later than the timing of the pulse output by the pulse generating circuit by a difference within a threshold time. In an embodiment, the phase control circuitry is configured to adjust the cycle of the pulse generating circuit to a shorter cycle if the rate of occurrence of a positive time shift is higher than the rate of occurrence of a negative time shift, and adjust the cycle of the pulse generating circuit to a longer cycle if the rate of occurrence of a negative time shift is higher than the rate of occurrence of a positive time shift. The cycle adjustments may be by a threshold increase or decrease of the length of the cycle, which may be small relative to the width of the pulse.

In an embodiment, the phase control circuitry is configured to carry out the phase control of the pulse from the pulse generating circuit by dividing a determined time (during which the pulse and the noise detection signal is to be synchronized) into two periods (a first half period and a second half period), and outputting the control signal to cause a positive time shift when the noise detection information from the noise detecting circuit is output in the first half period and outputting the control signal to cause a negative time shift when the noise detection information from the noise detecting circuit is output in the second half period.

In an embodiment, the pulse generating circuit outputs a pulse with the same time width at the same timing as the determined time. In an embodiment, the phase control circuitry is configured to carry out the phase control of the pulse from the pulse generating circuit in such a manner as to output the control signal to cause a positive time shift when the noise detection information from the noise detecting circuit appears at a rising edge of the pulse output by the pulse generating circuit and output the control signal to cause a negative time shift when the noise detection information from the noise detecting circuit appears at a falling edge of the pulse output by the pulse generating circuit.

### Advantageous Effect

In an embodiment, noise generated by the display device is detected and the pulse generating circuit that operates at a cycle corresponding to the synchronous frequency of the synchronizing pulse of the display device is provided. Furthermore, control is carried out to cause the timing of the pulse output by the pulse generating circuit to correspond with the timing of the noise generated by the display device, and signal detection is carried out in synchronization with the pulse output by the pulse generating circuit. In an embodiment, accurate detection of the coordinate position by the stylus or the finger without being affected by the noise generated by the display device is facilitated.

In an embodiment, a position detecting device detects a position indicated by a finger or a stylus over a display device. In an embodiment, the position detecting device comprises: a noise sensor, which, in operation, generates indications of noise; a noise detecting circuit, which, in operation, outputs noise detection signals based on indications of noise generated by the noise sensor; a pulse generating circuit, which, in operation, generates pulses having a periodic cycle based on a periodic cycle of a synchronizing pulse of the display device; phase control circuitry, which, in operation, controls a phase of the pulses generated by the pulse generating circuit to synchronize timing of the output of noise detection signals by the noise detecting circuit with timing of the pulses generated by the pulse generating circuit; and a receiving circuit, which, in operation, receives position signals in synchronization with the timing of the pulses generated by the pulse generating circuit. In an embodiment, the phase control circuitry, in operation, controls the phase of the pulses generated by the pulse generating circuit to maintain a rate of occurrence of synchronization of the noise detection signals output by the noise detecting circuit with the pulses generated by the pulse generating circuit, which is equal to or higher than a threshold value. In an embodiment, the phase control circuitry, in operation: generates control signals to apply a positive time shift to the pulses generated by the pulse generating circuit when a timing of the noise detection signals from the noise detecting circuit is earlier, by a difference within a threshold time, than a timing of the pulses output by the pulse generating circuit; generates control signals to apply a negative time shift to the pulses generated by the pulse generating circuit when the timing of the noise detection signals from the noise detecting circuit is later, by a difference within the threshold time, than the timing of the pulses output by the pulse generating circuit; adjusts the periodic cycle of the pulses generated by the pulse generating circuit to a shorter cycle when a rate of occurrence of the control signals to apply a positive time shift is higher than a rate of occurrence of the control signals to apply a negative time shift; and adjusts the periodic cycle of the pulses generated by the pulse generating circuit to a longer cycle when the rate of occurrence of the control signals to apply a negative time shift is higher than the rate of occurrence of the control signals to apply a positive time shift. In an embodiment, the phase control circuitry, in operation: generates control signals to apply a positive time shift to the pulses generated by the pulse generating circuit when the noise detection signals from the noise detecting circuit are output in a first half period of a synchronization period of the noise detection signals and the pulses generated by the pulse generating circuit; and generates control signals to apply a negative time shift to the pulses generated by the pulse generating circuit when the noise detection signals from the noise detecting circuit are output in a second half period of the synchronization period of the noise detection signals and the pulses generated by the pulse generating circuit. In an embodiment, the pulse generating circuit, in operation, generates pulses having a same time width as a synchronization time period of the noise detection signals and the pulses generated by the pulse generating circuit; and the phase control circuitry, in operation, generates control signals to apply a positive time shift to the pulses generated by the pulse generating circuit when the noise detection signals from the noise detecting circuit coincide with a rising edge of a pulse output by the pulse generating circuit, and generates control signals to apply a negative time shift to the pulses generated by the pulse generating circuit when the noise detection signals from the noise detecting circuit coincide with a falling edge of the pulse output by the pulse generating circuit. In an embodiment, the display device and a drive circuit of the display device are covered by a shield member; and the noise sensor is positioned outside the shield member, and, in operation, detects noise through an opening in the shield member. In an embodiment, the opening is positioned around the drive circuit of the display device; and the noise sensor, in operation, detects noise from the drive circuit of the display device. In an embodiment, a position of the opening corresponds to a position of an area including all or part of electrode lines along horizontal direction or vertical direction of the display device; and the noise sensor, in operation, detects noise from the electrode lines of the display device. In an embodiment, the noise detecting circuit, in operation, outputs a noise detection signal in response to an indication of noise above a threshold noise detection level.

In an embodiment, a method of detecting a position indicated by a finger or a stylus over a display device comprises: sensing, using a sensor of the display device, noise associated with the detecting of the indicated position; generating noise detection signals based on the sensing; generating pulses having a periodic cycle based on a periodic cycle of a synchronizing pulse of the display device; controlling a phase of the generated pulses to synchronize timing of the noise detection signals with timing of the generated pulses; and receiving position signals in synchronization with the timing of the generated pulses. In an embodiment, the method comprises: controlling the phase of the generated pulses to maintain a rate of occurrence of synchronization of the noise detection signals with the generated pulses which is equal to or higher than a threshold value. In an embodiment, the method comprises: generating control signals to apply a positive time shift to the generated pulses when a timing of the noise detection signals is earlier, by a difference within a threshold time, than a timing of the generated pulses; generating control signals to apply a negative time shift to the generated pulses when the timing of the noise detection signals is later, by a difference within the threshold time, than the timing of the generated pulses; adjusting the periodic cycle of the generated pulses to a shorter cycle when a rate of occurrence of the control signals to apply a positive time shift is higher than a rate of occurrence of the control signals to apply a negative time shift; and adjusting the periodic cycle of the generated pulses to a longer cycle when the rate of occurrence of the control signals to apply a negative time shift is higher than the rate of occurrence of the control signals to apply a positive time shift. In an embodiment, the method comprises: generating control signals to apply a positive time shift to the generated pulses when the noise detection signals occur during a first half period of a synchronization period of the noise detection signals and the generated pulses; and generating control signals to apply a negative time shift to the generated pulses when the noise detection signals occur during a second half period of the synchronization period of the noise detection signals and the generated pulses. In an embodiment, the method comprises: generating a pulse having a time width of a synchronization time window of the noise detection signals; generating control signals to apply a positive time shift to generated pulses when the noise detection signals coincide with a rising edge of the generated pulse; and generating control signals to apply a negative time shift to generated pulses when the noise detection signals coincide with a falling edge of the generated pulse. In an embodiment, the method comprises: shielding the display device using a shield, wherein the sensing noise comprises sensing noise an opening in the shield. In an embodiment, the sensing comprises sensing noise from a drive circuit of the display device.

In an embodiment, a system comprises: display circuitry, which, in operation, generates a display synchronization signal; and position detection circuitry, which, in operation: senses noise associated with detecting of position information; generates noise detection signals based on the sensing; generates noise synchronization pulses having a periodic cycle associated with a periodic cycle of the display synchronizing signal; controls a phase of the generated noise synchronization pulses to synchronize timing of the noise detection signals with timing of the generated noise synchronization pulses; and receives signals associated with the detecting of position information in synchronization with the timing of the generated noise synchronization pulses. In an embodiment, the position detection circuitry, in operation: generates control signals to apply a positive time shift to the generated noise synchronization pulses when a timing of the noise detection signals is earlier, by a difference within a threshold time, than a timing of the generated noise synchronization pulses; generates control signals to apply a negative time shift to the generated noise synchronization pulses when the timing of the noise detection signals is later, by a difference within the threshold time, than the timing of the generated noise synchronization pulses; adjusts the periodic cycle of the generated noise synchronization pulses to a shorter cycle when a rate of occurrence of the control signals to apply a positive time shift is higher than a rate of occurrence of the control signals to apply a negative time shift; and adjusts the periodic cycle of the generated noise synchronization pulses to a longer cycle when the rate of occurrence of the control signals to apply a negative time shift is higher than the rate of occurrence of the control signals to apply a positive time shift. In an embodiment, the system comprises: a stylus, which, in operation, indicates a position over the display circuitry.

### BRIEF DESCRIPTION OF DRAWINGS

FIG. 1 is a configuration diagram of a first embodiment of a position detecting device.

FIG. 2 is a diagram showing examples of the received signal waveforms of the respective parts in FIG. 1 and the timing of analog-to-digital (AD) conversion operation.

FIG. 3 is a diagram showing an embodiment of a circuit configuration of a phase control circuit configuring the first embodiment of the position detecting device.

FIGS. 4A, 4B, and 4C are diagrams showing examples of the signal waveforms of the respective parts in the phase control circuit of the example of FIG. 3.

FIG. 5 is a diagram showing part of a flowchart of an example program in a central processing unit (CPU) configuring the first embodiment of the position detecting device.

FIG. 6 is a diagram showing a continuation of the flowchart of the program in the CPU in FIG. 5.

FIG. 7 is a diagram showing another example of the phase control circuit configuring the first embodiment of the position detecting device.

FIGS. 8A, 8B, 8C and 8D are diagrams showing examples of the signal waveforms of the respective parts in the phase control circuit of FIG. 7.

FIG. 9 is a diagram showing part of a flowchart of an example program in a CPU in the example of FIG. 7.

FIG. 10 is a diagram showing a continuation of the flowchart of the program in the CPU in FIG. 9.

FIG. 11 is a diagram of an example of a noise sensor in the position detecting device according to the first embodiment.

FIG. 12 is a configuration diagram of a position detecting device according to a second embodiment.

FIG. 13 is a diagram showing another configuration example of the first embodiment of the position detecting device.

FIG. 14 is a diagram showing a configuration example of a system including an embodiment of the position detecting device.

FIGS. 15A and 15B are diagrams showing configuration examples of the noise sensor in the embodiment of the position detecting device.

FIG. 16 is a diagram showing a configuration example of a display device used in the system of the example of FIG. 14.

### EXAMPLE MODES

### First Embodiment

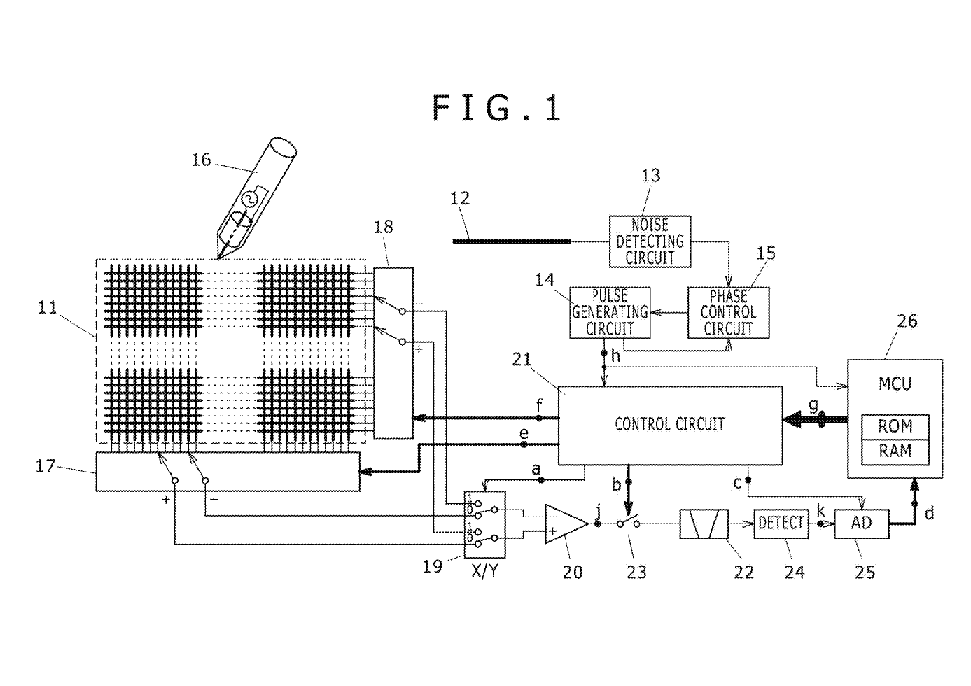

FIG. 1 is a configuration diagram of a first embodiment of a position detecting device. In FIG. 1, reference numeral 11 denotes a transparent sensor, and X electrodes made by arranging plural indium tin oxide (ITO) lines in the X-axis direction of the X and Y coordinates of the transparent sensor 11 and Y electrodes made by arranging plural ITO lines in the Y-axis direction of the X and Y coordinates. The transparent sensor 11 is disposed integrally with a liquid crystal display (LCD) panel, not shown in the diagram, and the position detection area of the transparent sensor 11 just overlaps with the display area of the LCD panel. The X electrodes and the Y electrodes over the transparent sensor 11 are connected to a printed board, not shown in the diagram, via a flexible board, not shown in the diagram, by an anisotropic conductive film (ACF) connection.

Reference numeral 12 denotes a noise detecting electrode as an example of a noise sensor provided outside the position detection area of the transparent sensor 11 and the noise detecting electrode 12 is connected to the printed board via the above-described flexible board. The noise detecting electrode 12 may be positioned along the longer sides and shorter sides of the transparent sensor 11 as shown by a dotted line in FIG. 1, may be extended into an L-shape, etc. In the case of an L-shape, one or both of the longer side and shorter side in the L-shaped extended part of the noise detecting electrode 12 may overlap with the position detection area of the transparent sensor 11.

Reference numeral 13 denotes a noise detecting circuit formed by an amplification circuit and a comparator. This noise detecting circuit 13 is connected to the noise detecting electrode 12 and sets the output to the high level when a noise voltage induced to the noise detecting electrode 12 surpasses a Reference numeral level. In the present embodiment, because the transparent sensor 11 is formed integrally with the LCD panel, the output from the noise detecting circuit 13 may be mainly attributed to noise from the LCD panel. Furthermore, in many cases, strong noise may also be generated in the X electrodes and the Y electrodes of the transparent sensor 11 at the same timing as the noise detected from the noise detecting circuit 13.

Reference numeral 14 denotes a pulse generating circuit that continuously generates a pulse of the same cycle as the cycle of the horizontal synchronizing pulse of the LCD panel. Most of the noise from the LCD panel is generated at the same cycle as the cycle of the horizontal synchronizing pulse. In the present embodiment, it is assumed that the periodic cycle of the horizontal synchronizing pulse of the LCD panel (horizontal synchronous frequency) may be known in advance.

Reference numeral 15 denotes a phase control circuit which in operation controls the phase of the pulse output from the pulse generating circuit 14 so that the pulse output from the pulse generating circuit 14 may correspond with the timing of the noise detected by the noise detecting circuit 13.

Reference numeral 16 denotes a stylus and a signal of a constant frequency is supplied between an electrode at the tip part and a peripheral electrode surrounding the electrode at the tip part of the stylus 16. Due to capacitive coupling between the stylus 16 and the transparent sensor 11, a signal is generated in the X electrodes and the Y electrodes of the transparent sensor 11.

Reference numeral 17 denotes an X selecting circuit that is connected to the X electrodes of the transparent sensor 11 and selects two pairs of electrodes from the X electrodes as a positive terminal and a negative terminal, and reference numeral 18 denotes a Y selecting circuit that is connected to the Y electrodes of the transparent sensor 11 and selects two pairs of electrodes from the Y electrodes as a positive terminal and a negative terminal.

Reference numeral 19 denotes a switching circuit which, in operation, selects either the positive terminal and the negative terminal selected by the X selecting circuit 17 or the positive terminal and the negative terminal selected by the Y selecting circuit 18 and connects the selected terminals to a differential amplification circuit 20. Specifically, when the X-axis coordinate of the position indicated by the stylus 16 is obtained, a control signal a from a control circuit 21 is set to the low level “0” to select the side of the X selecting circuit 17. Furthermore, when the Y-axis coordinate of the position indicated by the stylus 15 is obtained, the control signal a is set to the high level “1” to select the side of the Y selecting circuit 18. In this case, the positive terminal side of the X selecting circuit 17 or the Y selecting circuit 18 is connected to a non-inverting input terminal (positive side) of the differential amplification circuit 20 and the negative terminal side of the X selecting circuit 17 or the Y selecting circuit 18 is connected to an inverting input terminal (negative side) of the differential amplification circuit 20.

Reference numeral 22 denotes a band-pass filter circuit having a determined bandwidth centered at the frequency of the signal output by the stylus 16 and an output signal from the differential amplification circuit 20 is supplied to the band-pass filter circuit 22 via a switch 23. The switch 23 is controlled to the on- or off-state by a control signal b from the control circuit 21. Specifically, when the control signal b is at the high level “1,” the switch 23 is set to the on-state and the output signal from the differential amplification circuit 20 is supplied to the band-pass filter circuit 22. When the control signal b is at the low level “0,” the switch 23 is set to the off-state and the output signal from the differential amplification circuit 20 is not supplied to the band-pass filter circuit 22.

An output signal of the band-pass filter circuit 22 is subjected to detection by a detection circuit 24 and is converted to a digital value by an analog-digital conversion circuit (hereinafter, abbreviated as the AD conversion circuit) 25 based on a control signal c from the control circuit 21. Digital data d from this AD conversion circuit 25 is read and processed by a microprocessor 26 (MCU).

The control circuit 21 supplies a control signal e to the X selecting circuit 17 and thereby the X selecting circuit 17 selects two pairs of X electrodes as the positive terminal and the negative terminal. Furthermore, the control circuit 21 supplies a control signal f to the Y selecting circuit 18 and thereby the Y selecting circuit 18 selects two pairs of Y electrodes as the positive terminal and the negative terminal.

Reference numeral 26 denotes an MCU and it internally includes a read-only memory (ROM) and a random access memory (RAM) and executes a program stored in the ROM.

The microprocessor 26 internally includes the ROM and the RAM and operates by executing the program stored in the ROM.

The microprocessor 26 outputs a control signal g based on the program stored in the ROM to control the control circuit 21 so that the control circuit 21 may output the control signals a to fat determined timings.

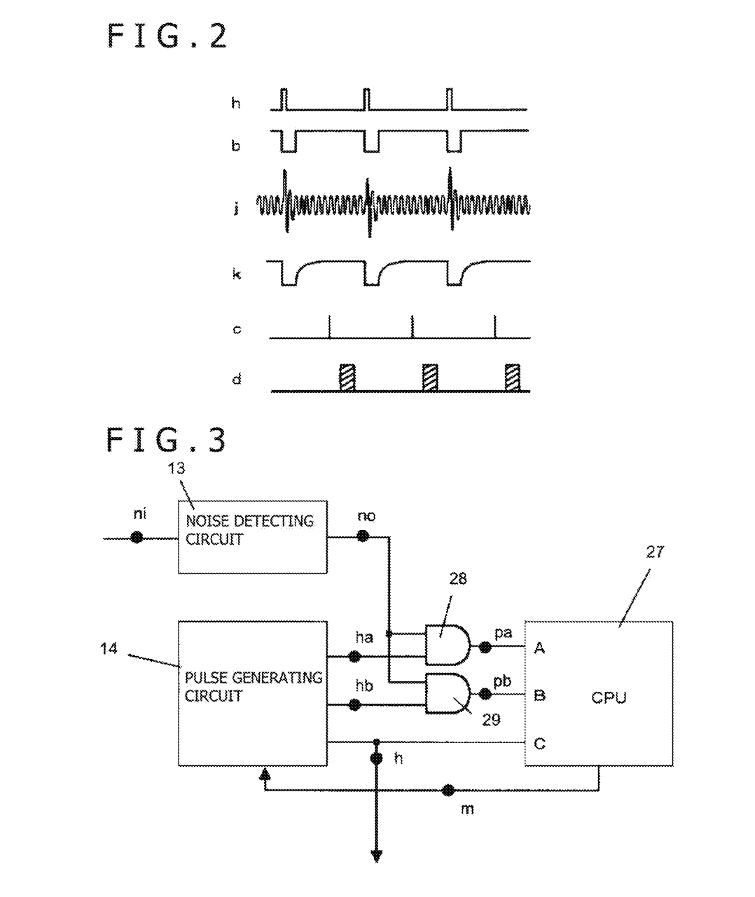

A pulse h output from the pulse generating circuit 14 is supplied to the control circuit 21 and the microprocessor 26 and the overall operation is carried out at the cycle of the pulse h, e.g., the horizontal synchronizing pulse (horizontal synchronous frequency) of the LCD panel. FIG. 2 is a diagram showing the received signal waveforms and the timing of AD conversion operation in the state in which the X selecting circuit 17 or the Y selecting circuit 18 selects electrodes close to the stylus 16. In FIG. 2, reference symbols h, b, j, k, c, and d designate signal waveforms at the places indicated by the same symbols in FIG. 1. The symbol “j” represents the output signal waveform of the differential amplification circuit 20 and symbol k represents the output signal waveform of the detection circuit 24. A signal transmitted from the stylus 16 appears in the output j of the differential amplification circuit 20. However, strong noise from the LCD panel may be generated at the timing of the pulse h output from the pulse generating circuit 14. Executing signal detection (AD conversion) with avoidance of this noise from the LCD panel may be facilitated by the present embodiment.

The switch 23 is turned off at timings synchronizing with the pulse h and thereby the noise appearing in the output of the differential amplification circuit 20 is not input to the band-pass filter circuit 22. Thus, the conversion result d by the AD conversion circuit 25 is not affected by the noise.

In the present embodiment, in the state in which the switching circuit 19 selects the X side, the electrodes selected by the X selecting circuit 17 are sequentially switched at the timings of the above-described pulse h and signal detection is carried out. Then, the X coordinate of the position indicated by the stylus 16 is obtained from the distribution of the conversion result d by the AD conversion circuit 25. Furthermore, in the state in which the switching circuit 19 selects the Y side, the electrodes selected by the Y selecting circuit 18 are sequentially switched at the timings of the above-described pulse h and signal detection is carried out. Then, the Y coordinate of the position indicated by the stylus 16 is obtained from the distribution of the conversion result d by the AD conversion circuit 25.

The above-described phase control circuit 15 causes the timing of the pulse output from the pulse generating circuit 14 to correspond with the timing of the noise detected by the noise detecting circuit 13, as discussed in more detail herein.

FIG. 3 is a diagram showing a specific circuit configuration of the phase control circuit 15 in FIG. 1. In FIG. 3, the noise detecting circuit 13 and the pulse generating circuit 14 are the same as those in FIG. 1. Reference numeral 27 denotes a CPU and reference numerals 28 and 29 denote AND gates.

An output signal no from the noise detecting circuit 13 is supplied in common to one input terminal of each of the AND gates 28 and 29. To the other input terminal of the AND gate 28, a signal ha output as the high level in the period equivalent to the first half period of the above-described pulse h output from the pulse generating circuit 14 is supplied. To the other input terminal of the AND gate 29, a signal hb output as the high level in the period equivalent to the second half period of the pulse h output from the pulse generating circuit 14 is supplied.

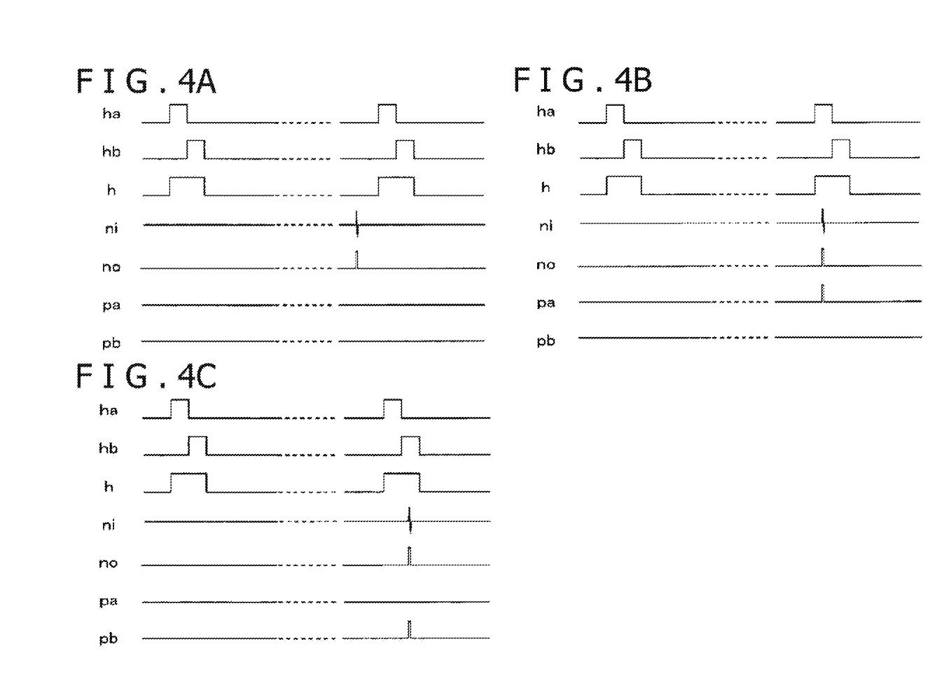

In the CPU 27, interrupt input terminals A, B, and C are provided. An output signal pa from the AND gate 28 is supplied to the interrupt input terminal A. An output signal pb from the AND gate 29 is supplied to the interrupt input terminal B. The pulse h output from the pulse generating circuit 14 is supplied to the interrupt input terminal C. The CPU 27 is so programmed that determined interrupt processing operation is carried out every time a rising edge of the signals input to the respective interrupt input terminals A, B, and C is generated. FIGS. 4A, 4B and 4C show examples of the signal waveforms of the respective parts shown in the phase control circuit of FIG. 3.

In FIGS. 4A, 4B and 4C, the following signals are shown: the pulse h of the horizontal cycle from the pulse generating circuit 14, the pulse ha whose pulse width is the first half period of the pulse width of pulse h, the pulse hb whose pulse width is the second half period of the pulse width of the pulse h, an input signal ni of the noise detecting circuit 13, the output signal no, the output signal pa of the AND gate 28, and the output signal pb of the AND gate 29.

FIG. 4A is the case in which the output signal (noise) no from the noise detecting circuit 13 appears in a period other than the pulse width period of the output pulse h from the pulse generating circuit 14. For example, the noise appears before the operation of the phase control circuit becomes a steady state, such as immediately after the position detecting device is activated.

FIG. 4B shows the case in which the output signal no from the noise detecting circuit 13 appears in the first half period of the pulse width of the output pulse h from the pulse generating circuit 14 (pulse width period of the pulse ha). Furthermore, FIG. 4C shows the case in which the output signal no from the noise detecting circuit 13 appears in the second half period of the pulse width of the output pulse h from the pulse generating circuit 14 (pulse width period of the pulse hb).

In the phase control circuit, the CPU 27 controls the phase of the pulses h output by the pulse generating circuit 14 to synchronize a timing of the output signal no (noise detection information) from the noise detecting circuit 13 with a timing of the pulses h output by the pulse generating circuit 14. In an embodiment, the phase control circuitry controls the phase of the pulses generated by the pulse generating circuit to maintain a rate of occurrence of synchronization of the noise detection signals output by the noise detecting circuit with the pulses generated by the pulse generating circuit, which is equal to or higher than a threshold value.

More specifically, when the timing at which the output signal no (noise detection information) from the noise detecting circuit 13 is output appears earlier than the timing of the pulse h output by the pulse generating circuit 14 by a difference within a threshold time, the CPU 27 outputs control information to the pulse generating circuit 14 as a control signal m indicating a positive time shift is to be applied to the pulse h. When the timing at which the noise detection information from the noise detecting circuit 13 is output appears later than the timing of the pulse h output by the pulse generating circuit 14 by a difference within a threshold time, the CPU 27 outputs control information to the pulse generating circuit 14 as the control signal m indicating a negative time shift is to be applied to the pulse h. When the rate of occurrence of the control information to cause a positive time shift is higher than the rate of occurrence of the control information to cause a negative time shift, the cycle of the pulse h output by the pulse generating circuit 14 is adjusted to be shorter. When the rate of occurrence of the control information to cause a negative time shift is higher than the rate of occurrence of the control information to cause a positive time shift, the cycle of the pulse h output by the pulse generating circuit 14 is adjusted to be longer.

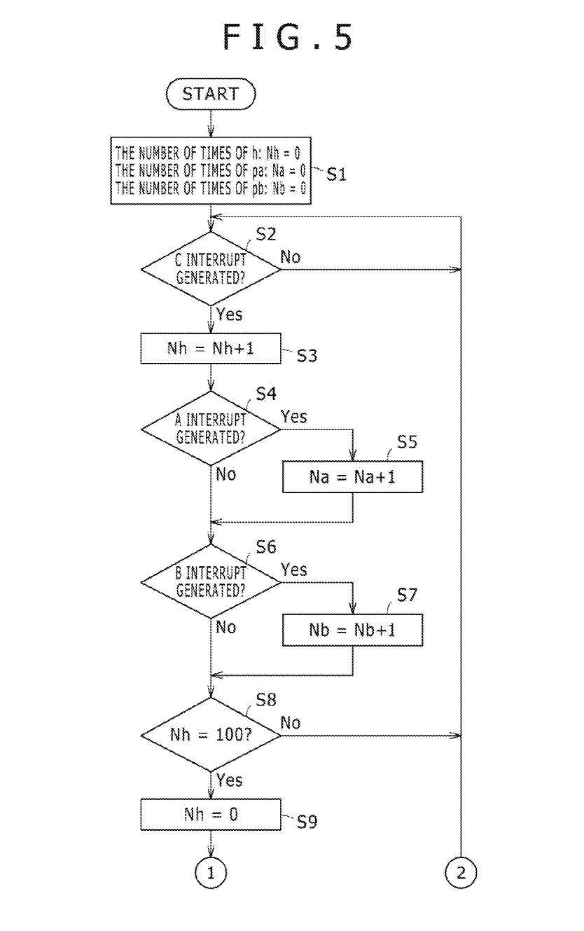

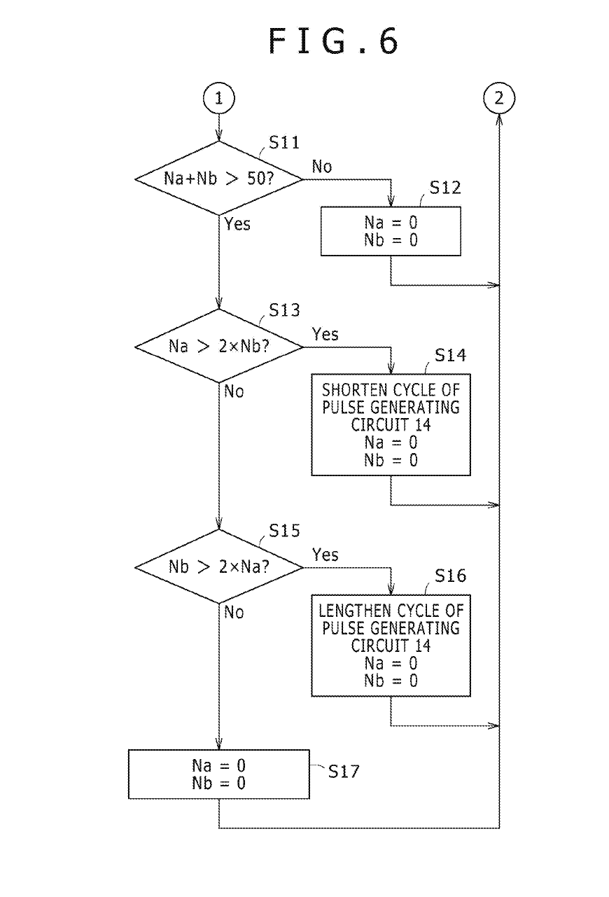

FIG. 5 and FIG. 6, which is a continuation of FIG. 5, show a flowchart of a program in the CPU 27. When the position detecting device is powered up, the CPU 27 clears all of the values of the number Nh of times of interrupt generation by the interrupt input terminal C, the number Na of times of interrupt generation by the interrupt input terminal A, and the number Nb of times of interrupt generation by the interrupt input terminal B (step S1).

Next, the CPU 27 waits until an interrupt by the interrupt input terminal C is generated (step S2). When an interrupt by the interrupt input terminal C is generated, the CPU 27 adds one to the value of the number Nh of times of interrupt generation (step S3).

Next, the CPU 27 checks whether an interrupt by the interrupt input terminal A has been generated (step S4). If an interrupt by the interrupt input terminal A has been generated, the CPU 27 adds one to the value of the number Na of times of interrupt generation (step S5).

Next, the CPU 27 checks whether an interrupt by the interrupt input terminal B has been generated (step S6). If an interrupt by the interrupt input terminal B has been generated, the CPU 27 adds one to the value of the number Nb of times of interrupt generation (step S7).

Next, the CPU 27 checks the value of the number Nh of times of interrupt generation (step S8). If the value of the number Nh of times of interrupt generation has not become 100, the CPU 27 returns the processing to the step S2 and repeatedly carries out the processing from the step S2 to the step S8 until the number Nh of times of interrupt generation=100 is obtained. If the value of the number Nh of times of interrupt generation has become a threshold number, such as 100, the CPU 27 clears the value of the number Nh of times of interrupt generation (Nh=0) (step S9).

Next, the CPU 27 checks the values of the number Na of times of interrupt generation and the number Nb of times of interrupt generation and determines whether or not the sum of the number Na of times of interrupt generation and the number Nb of times of interrupt generation is equal to or larger than a determined value (here, 50) (step S11 in FIG. 6). If the sum of the number Na of times of interrupt generation and the number Nb of times of interrupt generation does not reach 50 as the determined value here, the CPU 27 clears the values of the number Na of times of interrupt generation and the number Nb of times of interrupt generation (Na=0, Nb=0) (step S12) and then returns the processing to the step S2. Furthermore, if the sum of the number Na of times of interrupt generation and the number Nb of times of interrupt generation is equal to or larger than 50 as the determined value, the CPU 27 determines that the timing of the pulse output by the pulse generating circuit 14 roughly corresponds with the timing of the noise detected by the noise detecting circuit 13, and shifts the processing to the next step S13 for carrying out detailed control of the phase.

The situation in which the sum of the number Na of times of interrupt generation and the number Nb of times of interrupt generation does not reach the determined value in the above-described step S11 generally occurs only immediately after the power activation. In the steady state, the sum of the number Na of times of interrupt generation and the number Nb of times of interrupt generation generally becomes equal to or larger than the determined value. Furthermore, in an embodiment, the determined value is selected in such a manner that the sum usually becomes equal to or larger than the determined value in the steady state. This determined value may be decided based on the deviation between the cycle of generation of the pulse output by the pulse generating circuit 14 normally (when phase control to be described later is not carried out) and the cycle of the horizontal synchronizing pulse of the horizontal synchronous frequency of the LCD panel, and how accurately the noise detected by the noise detecting circuit 13 corresponds to the timing of the horizontal synchronizing pulse of the LCD panel, and so forth. That is, the pulse output by the pulse generating circuit 14 generally greatly deviates from the pulse output by the noise detecting circuit 13 immediately after the power activation. However, with the elapse of time, the output no from the noise detecting circuit 13 comes to fall within the pulse width period of the pulse h output from the pulse generating circuit 14 as shown in FIG. 4C.

If the sum of the number Na of times of interrupt generation and the number Nb of times of interrupt generation is equal to or greater than the determined value in the step S11, the CPU 27 compares the values of the number Na of times of interrupt generation and the number Nb of times of interrupt generation and carries out the phase control. First, in the step S13, the CPU 27 determines whether or not the number Na of times of interrupt generation is sufficiently larger (here, twice or larger) compared with the number Nb of times of interrupt generation.

If determining in the step S13 that the number Na of times of interrupt generation is sufficiently larger compared with the number Nb of times of interrupt generation, the CPU 27 sends out the control signal m to control the pulse generating circuit 14 so as to shorten the cycle of the pulse h output from the pulse generating circuit 14. Furthermore, the CPU 27 clears the values of the number Na of times of interrupt generation and the number Nb of times of interrupt generation (step S14). Then, the CPU 27 returns the processing to the step S2.

If determining in the step S13 that the number Na of times of interrupt generation is not larger (here, by at least a multiple of 2) compared with the number Nb of times of interrupt generation, conversely the CPU 27 determines whether or not the number Nb of times of interrupt generation is sufficiently larger (here, twice or larger) compared with the number Na of times of interrupt generation (step S15). If determining that the number Nb of times of interrupt generation is sufficiently larger compared with the number Na of times of interrupt generation, the CPU 27 sends out the control signal m to control the pulse generating circuit 14 so as to lengthen the cycle of the pulse generating circuit 14. Furthermore, the CPU 27 clears the values of the number Na of times of interrupt generation and the number Nb of times of interrupt generation (step S16). Then, the CPU 27 returns the processing to the step S2.

If the CPU 27 determines in the step S15 that the number Nb of times of interrupt generation is not larger compared with the number Na of times of interrupt generation, e.g. if the CPU 27 determines that the ratio is low (here, twice or lower) through the comparison between the number Na of times of interrupt generation and the number Nb of times of interrupt generation, the pulse of the output no from the noise detecting circuit 13 exists just around the center of the pulse width period of the output pulse h from the pulse generating circuit 14. Thus, the CPU 27 does not carry out the phase control and clears the values of the number Na of times of interrupt generation and the number Nb of times of interrupt generation (step S17). Then, the CPU 27 returns the processing to the step S2.

The processing of the above-described step S13 and step S15 will be described in a little more detail. That the number Na of times of interrupt generation is equal to or larger than twice the number Nb of times of interrupt generation in the step S13 indicates that the rate of occurrence at which the state of FIG. 4B is obtained is high. Thus, the CPU 27 shortens the cycle of the pulse h output from the pulse generating circuit 14 once to advance the phase of the pulse h and thereby carries out control to equalize the values of the number Na of times of interrupt generation and the number Nb of times of interrupt generation. Furthermore, that the number Nb of times of interrupt generation is equal to or larger than twice the number Na of times of interrupt generation in the step S15 indicates that the rate of occurrence at which the state of FIG. 4C is obtained is high. Thus, the CPU 27 lengthens the cycle of the pulse h output from the pulse generating circuit 14 once to retard the phase of the pulse h and thereby carries out control to equalize the values of the number Na of times of interrupt generation and the number Nb of times of interrupt generation.

In an embodiment, the ratio with which the number Na of times of interrupt generation and the number Nb of times of interrupt generation are compared and the determination is carried out in the step S13 and the step S15 is decided corresponds to the fineness of the time adjustment of the cycle of the pulse h output from the above-described pulse generating circuit 14. Specifically, when the amount of the above-described adjustment is lower, the determination ratio between the number Na of times of interrupt generation and the number Nb of times of interrupt generation may be set to a smaller value. However, when the amount of adjustment is larger, the determination ratio between the number Na of times of interrupt generation and the number Nb of times of interrupt generation may be set to a larger value.

It goes without saying that the MCU 26 may be used in place of the CPU 27.

Another Example of Phase Control Circuit

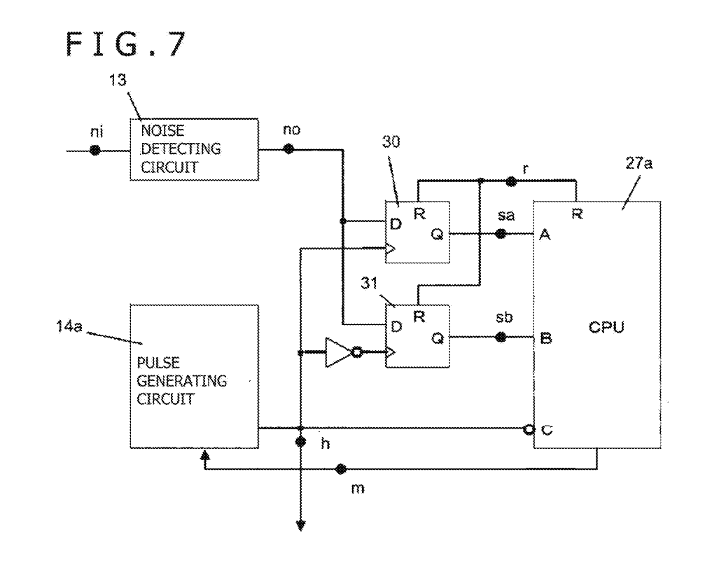

FIG. 7 is a diagram showing another example of the phase control circuit and parts having the same configuration as FIG. 3 are shown with the same numerals. Reference numeral 27a denotes a CPU and reference numerals 30 and 31 denote flip-flops.

The output signal no from the noise detecting circuit 13 is supplied in common to data terminals D of the flip-flop 30 and the flip-flop 31. A pulse h from a pulse generating circuit 14a is supplied to the clock input of the flip-flop 30 and the inverted signal of the pulse h from the pulse generating circuit 14a is supplied to the clock input of the flip-flop 31.

That is, the flip-flop 30 holds the value of the output no from the noise detecting circuit 13 at the rising edge of the pulse h and supplies the result thereof as a signal sa to an input terminal A of the CPU 27a. Furthermore, the flip-flop 31 holds the value of the output no from the noise detecting circuit 13 at the falling edge of the pulse h and supplies the result thereof as a signal sb to an input terminal B of the CPU 27a.

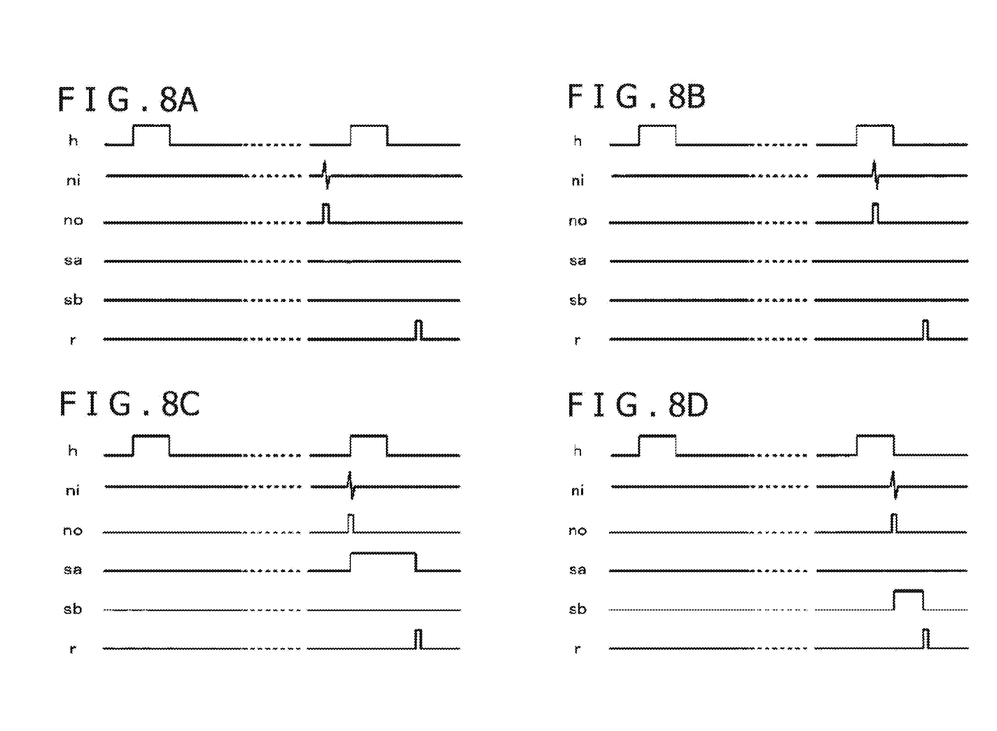

Furthermore, the pulse h from the pulse generating circuit 14a is input to an interrupt input terminal C of the CPU 27a and determined interrupt processing operation is carried out at the falling edge of the pulse h. FIGS. 8A, 8B, 8C and 8D show examples of the signal waveforms of the respective parts shown in the phase control circuit of FIG. 7.

FIG. 8A illustrates the case in which the output signal no from the noise detecting circuit 13 appears in a pulse width period other than the output pulse h from the pulse generating circuit 14a. The state of FIG. 8A generally appears before the operation of the phase control circuit becomes a steady state operation, such as immediately after the position detecting device is activated.

FIG. 8B illustrates the case in which the output signal no from the noise detecting circuit 13 appears just around the middle of the pulse width period of the pulse h from the pulse generating circuit 14a. In the steady state, the operation shown in FIG. 8B frequently appears.

FIG. 8C shows the case in which the output signal no from the noise detecting circuit 13 becomes the high level just at the timing of the rising edge of the pulse h from the pulse generating circuit 14a. FIG. 8D shows the case in which the output signal no from the noise detecting circuit 13 becomes the high level just at the timing of the falling edge of the pulse h from the pulse generating circuit 14a.

Also in this phase control circuit of the example of FIG. 7, the CPU 27a controls the phase of the pulses h output by the pulse generating circuit 14 to maintain a rate of occurrence of synchronization of the noise detection signals no output by the noise detecting circuit 13 with the pulses h generated by the pulse generating circuit, which is equal to or higher than a threshold value.

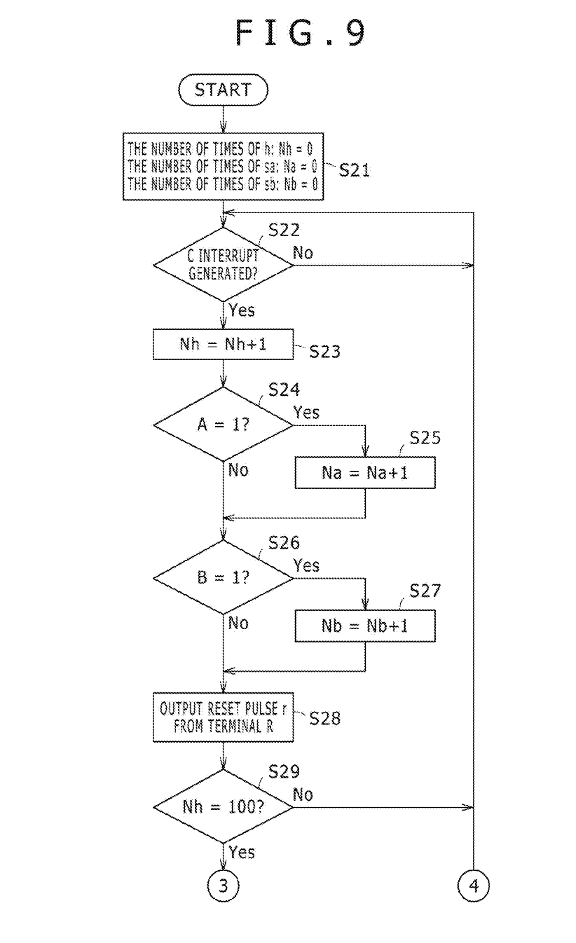

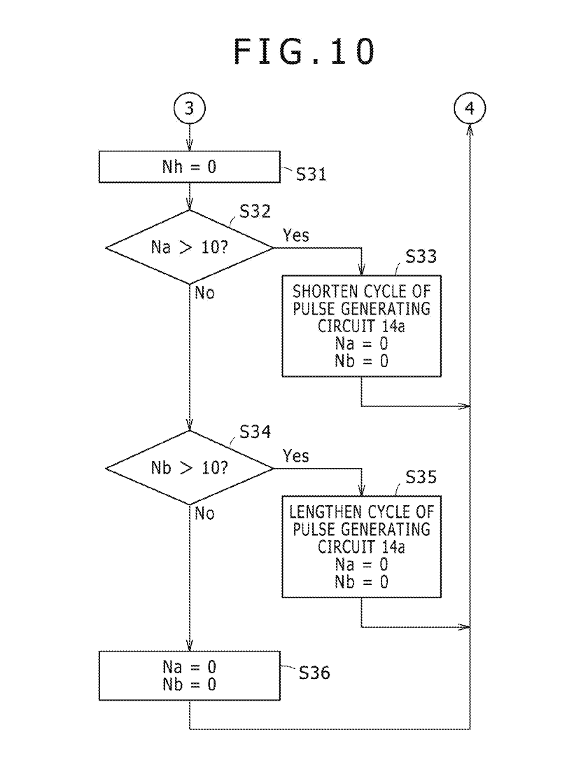

FIG. 9 and FIG. 10, which is a continuation of FIG. 9, show a flowchart of a program in the CPU 27a. When the position detecting device is powered up, the CPU 27a clears all of the values of the number Nh of times of interrupt generation by the interrupt input terminal C, the number Na of times the input terminal A is at the high level at the time of interrupt generation of the interrupt input terminal C, and the number Nb of times the input terminal B is at the high level at the time of interrupt generation of the interrupt input terminal C (step S21).

Next, the CPU 27a waits until an interrupt by the interrupt input terminal C is generated (step S22). When an interrupt by the interrupt input terminal C is generated, the CPU 27a adds one to the value of the number Nh of times of interrupt generation and advances the processing to the next step 24 (step S23).

Next, the CPU 27a checks whether the input terminal A is at the high level (step S24). If the input terminal A is at the high level, the CPU 27a adds one to the value of the number Na of times (step S25).

Next, the CPU 27a checks whether the input terminal B is at the high level (step S26). If the input terminal B is at the high level, the CPU 27a adds one to the value of the number Nb of times (step S27).

After ending the processing to the step S26 or the step S27, the CPU 27a outputs a reset pulse r from a terminal R (step S28). The outputs (Qa and Qb) of the flip-flop 30 and the flip-flop 31 are cleared by this reset pulse r.

Next, the CPU 27a checks the value of the number Nh of times of interrupt generation and determines whether or not the value of the number Nh of times of interrupt generation has become a threshold number, as illustrated 100 (step S29). If the value of the number Nh of times of interrupt generation has not become 100, the CPU 27a returns the processing to the step S22 and repeatedly carries out the processing from the step S22 to the step S29 until the number Nh of times of interrupt generation=100 is obtained.

If determining in the step S29 that the value of the number Nh of times of interrupt generation has become 100, the CPU 27a clears the value of the number Nh of times of interrupt generation (step S31 in FIG. 10).

Next, the CPU 27a checks the values the number Na of times and the number Nb of times and carries out the phase control. First, the CPU 27a determines whether or not the number Na of times is larger than a determined value (here, 10) (step S32). If the number Na of times is larger than the determined value (here, 10), the CPU 27a sends out the control signal m to control the pulse generating circuit 14a so as to shorten the cycle of the pulse h from the pulse generating circuit 14a. Furthermore, the CPU 27a clears the values of the number Na of times and the number Nb of times (step S33). Then, the CPU 27a returns the processing to the step 22.

Next, if determining in the step S32 that the number Na of times is equal to or smaller than the determined value (here, 10), the CPU 27a determines whether or not the number Nb of times is larger than a determined value (here, 10) (step S34). If the number Nb of times is larger than the determined value (here, 10), the CPU 27a sends out the control signal m to control the pulse generating circuit 14a so as to lengthen the cycle of the pulse h from the pulse generating circuit 14a. Furthermore, the CPU 27a clears the values of the number Na of times and the number Nb of times (step S35). Then, the CPU 27a returns the processing to the step 22.

The processing of the above-described step S32 to step S35 will be described in a little more detail. That the number Na of times is larger than the determined number (here, 10) in the step S32 indicates that the phase of the pulse h output by the pulse generating circuit 14a is delayed compared with the timing of the output pulse no from the noise detecting circuit 13. Therefore, the state of the operation can be brought closer to the state of FIG. 8B by shortening the cycle of the pulse h output by the pulse generating circuit 14a to advance the phase of the output pulse h.

Furthermore, that the number Nb of times is larger than the determined number (here, 10) in the step S34 indicates that the phase of the pulse h output by the pulse generating circuit 14a is advanced compared with the timing of the output pulse no from the noise detecting circuit 13. Therefore, the state of the operation can be brought closer to the state of FIG. 8B by lengthening the cycle of the pulse output by the pulse generating circuit 14a to retard the phase of the output pulse h.

Although the value with which the determination is carried out based on the number Na of times and the number Nb of times in the step S32 and the step S34 is set to 10 here, in an embodiment this value may be determined to correspond to the fineness of the time adjustment when the cycle of the pulse h output by the above-described pulse generating circuit 14a is adjusted, the variation and frequency of the level of the noise emitted by the LCD panel, and so forth.

In the present embodiment, the processing is executed based on the frequencies of the output of the above-described pa, sa, pb, and sb in the period during which the pulse generating circuit 14 and the pulse generating circuit 14a output the pulse 100 times. However, this number of times may be another number of times other than 100 times.

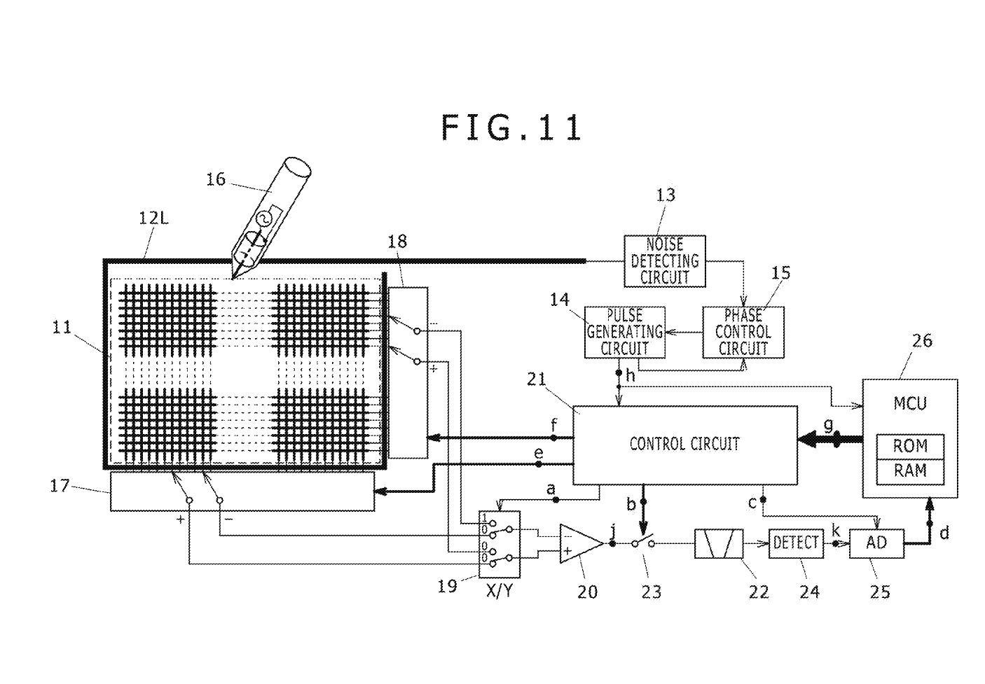

In the present embodiment, the noise sensor is formed by the noise detecting electrode 12. However, for example as shown in FIG. 11, the noise sensor may be formed by a loop-shaped coil 12L surrounding the transparent sensor 11 and noise may be detected by this coil 12L.

In the present embodiment, the position indicated by the stylus 16 is obtained by capacitive coupling with the transparent sensor 11. However, the embodiment can be applied also to the case in which a transparent sensor is provided with a loop coil and a stylus is also provided with a coil and the position indicated by the stylus is obtained by electromagnetic induction.

In the present embodiment, the control circuit 21 is for avoiding or offloading the concentration of processing in the microprocessor 26 and the control circuit 21 may be absent.

In the present embodiment, the coordinate detection on the X-axis side and the coordinate detection on the Y-axis side are carried out with switching by the switching circuit 19. However, a differential amplification circuit, an AD conversion circuit, and so forth may be provided on the X-axis side and the Y-axis side severally and reception processing may be executed simultaneously.

It goes without saying that the MCU 26 may be used in place of the CPU 27a in the above-described embodiment.

### Second Embodiment

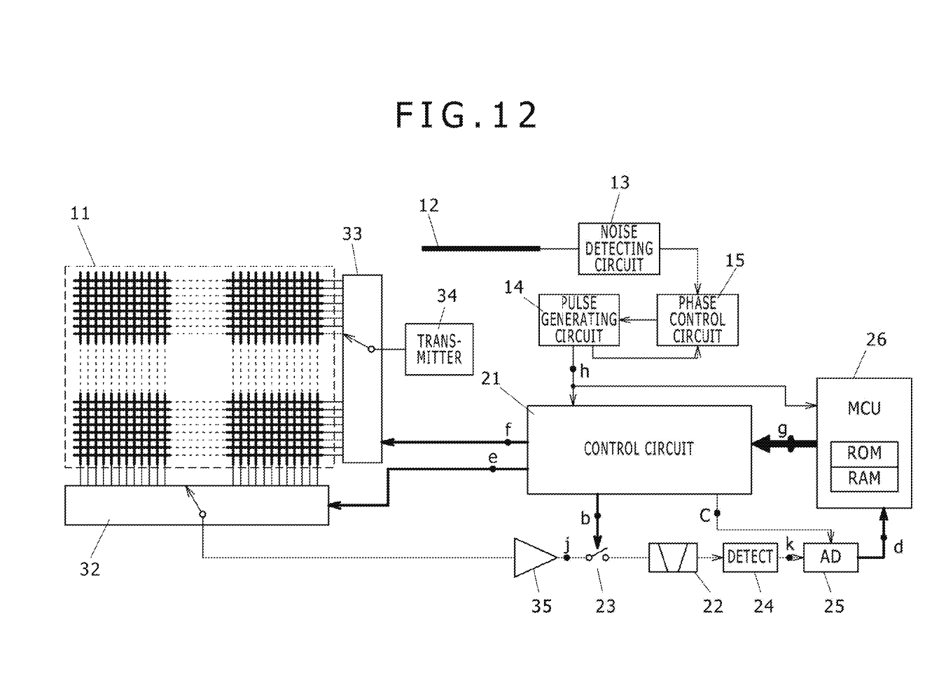

FIG. 12 is a configuration diagram of a position detecting device according to a second embodiment and shows an example of the case in which the position touched by a finger is detected and input. In FIG. 12, the same constituent elements as FIG. 1 are shown with the same reference numerals. Specifically, numeral 11 denotes a transparent sensor, 12 denotes a noise detecting electrode, 13 denotes a noise detecting circuit, 14 denotes a pulse generating circuit, 15 denotes a phase control circuit, 21 denotes a control circuit, 22 denotes a band-pass filter circuit, 23 denotes a switch, 24 denotes a detection circuit, 25 denotes an AD conversion circuit, and 26 denotes a microprocessor.

Reference numeral 32 denotes an X selecting circuit that selects one electrode from the X electrodes of the transparent sensor 11, and reference numeral 33 denotes a Y selecting circuit that selects one electrode from the Y electrodes of the transparent sensor 11. Reference numeral 34 denotes a transmitter that generates and outputs a signal of a selected frequency. The output signal of the transmitter 34 is supplied to the Y selecting circuit 33 to drive the Y electrode of the transparent sensor 11 selected by the Y selecting circuit 33.

Reference numeral 35 denotes an amplification circuit and it is connected to the X selecting circuit 32 and amplifies a signal generated in the X electrode of the transparent sensor 11 selected by the X selecting circuit 32.

This second embodiment is a multi-touch sensor that obtains the position touched by a finger by utilizing the fact that the coupling capacitance at the cross point of the X electrode and the Y electrode changes when the finger approaches. Also in this kind of position detecting device, conventionally there is a problem that noise from a display device enters the position detecting device and therefore the drive voltage needs to be set high, and so forth.

Also in the present embodiment, the signal waveforms shown at the respective parts in FIG. 12 are the same as FIG. 2, and the signal detected from the X electrode of the transparent sensor 11 can be detected with avoidance of the period in which strong noise from the display device is generated. Thus, the touch position may be reliably detected without setting the output voltage of the transmitter 34 very high.

### Effect of Embodiments

In an embodiment, noise generated by the display device is detected and the pulse generating circuit operates at a cycle corresponding to the horizontal synchronous frequency of the display device, which may be known in advance is provided. Furthermore, control is carried out to cause the timing of the pulse output by the pulse generating circuit to correspond with the timing of the noise generated by the display device, and signal detection is carried out in synchronization with the pulse output by the pulse generating circuit. Therefore, the accurate detection and input of the coordinate position by a stylus or a finger without being affected by the noise generated by the display device is facilitated.

### Other Embodiments

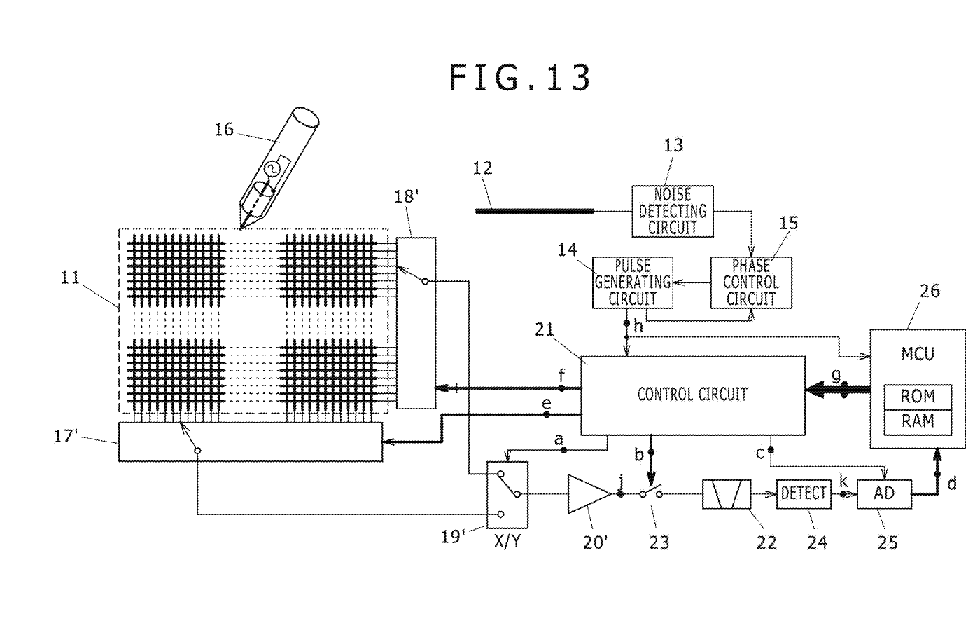

In the above-described first embodiment, noise superimposed on two receiving electrodes similarly is canceled by using the differential amplification circuit 20. However, the signal is not supplied to the band-pass filter circuit 22 by turning off the switch 23 in the period in which the display device emits the noise. Therefore, as shown in FIG. 13, the position detecting device may be configured to use an amplification circuit 20′ without using the differential amplification circuit 17. In this case, as shown in FIG. 13, an X selecting circuit 17′ and a Y selecting circuit 18′ have such a configuration as to select one X electrode and one Y electrode, respectively. Furthermore, a switching circuit 19′ has such a configuration as to select either the one X electrode selected by the X selecting circuit 17′ or the one Y electrode selected by the Y selecting circuit 18′.

Furthermore, in the above-described embodiment, the case of detection of the position indicated by a stylus (position indicator) of the capacitive system is described. However, an embodiment may be applied also in a position detecting device that detects the position indicated by a stylus (position indicator) of the electromagnetic induction system.

Configuration Examples of Noise Sensor

As explained in the above-described embodiments, the noise sensors 12 and 12L are disposed at the periphery of the LCD panel disposed integrally with the transparent sensor. Specific configuration examples of the noise sensor and examples of the placement position will be described below.

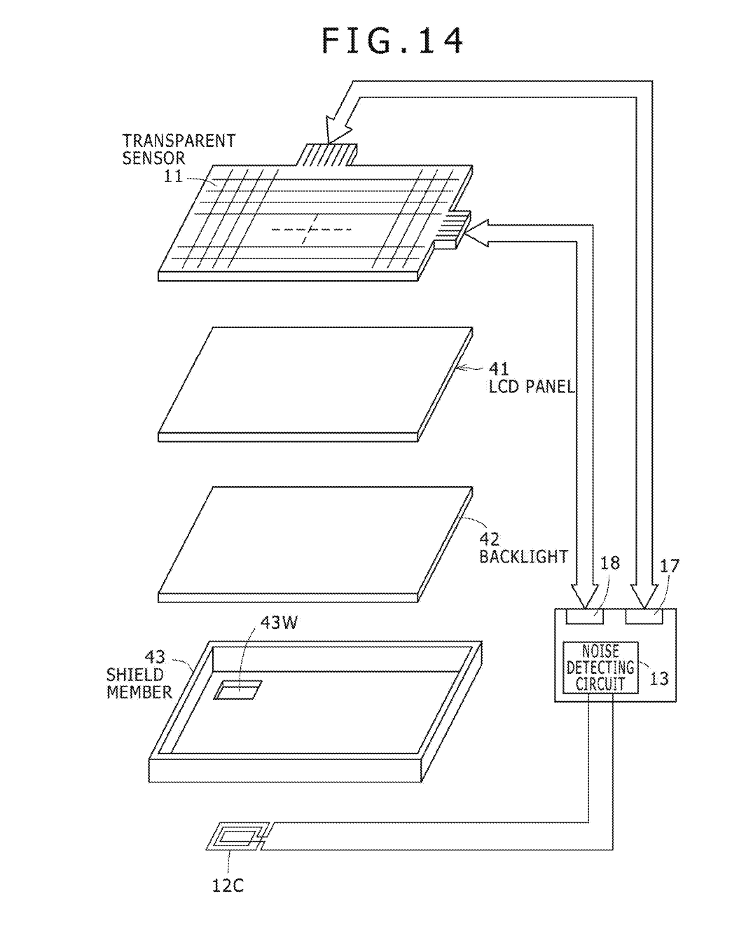

FIG. 14 is a diagram showing a specific configuration example of a liquid crystal unit or system including the transparent sensor 11 and an LCD panel 41. This liquid crystal unit forms also a position detecting device unit or system. As shown in FIG. 14, the LCD panel 41 is disposed under the transparent sensor 11 and a backlight 42 is disposed under the LCD panel 41, so that the liquid crystal unit is configured. The liquid crystal unit of this example is for portable equipment such as a mobile phone terminal called a smartphone for example.

Furthermore, in the liquid crystal unit of this example, the transparent sensor 11, the LCD panel 41, and the backlight 42 forming the liquid crystal unit are enclosed by a shield member 43 formed of an electrically-conductive member such as a copper foil and an aluminum foil for example. This shield member 43 plays a role in blocking noise so that the noise generated from the LCD panel 41 may be prevented from affecting a circuit part (diagrammatic representation is omitted) of the portable equipment main body. Furthermore, against heat generation of the backlight 42, the shield member 43 is also used to block heat to the liquid crystal screen of the LCD panel 41 and cause the circuit part of the portable equipment main body to dissipate heat.

In the case of the configuration of the liquid crystal unit (position detecting device unit) in which the shield member 43 like this example of FIG. 14 is not provided, the noise sensor can be disposed e.g. by being laid around the LCD panel as in the embodiments shown in FIG. 13 and so forth. However, in the case of the structure in which the LCD panel 41, the transparent sensor 11, and the backlight 42 forming the liquid crystal unit are encompassed by the shield member 43 as shown in FIG. 14, the liquid crystal unit is configured to keep the noise to the external from leaking by the shield member 43. Thus, the configuration of disposing the noise sensor may be based on consideration of the presence of the shield member.

In this example, as shown in FIG. 14, an opening 43W is formed at one part of the bottom surface part of the shield member 43. A noise sensor 12C of this example is disposed on the outside surface of the shield member 43 (back side of the bottom surface) in such a manner as to be capable of detecting noise discharged from the LCD panel 41 through this opening 43W.

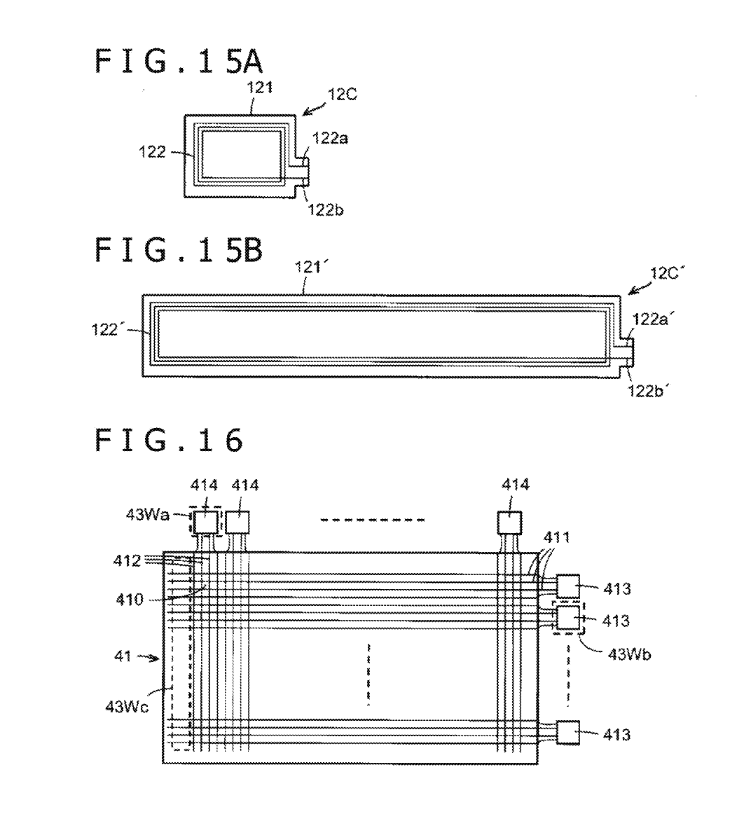

FIG. 15A shows a configuration example of the noise sensor 12C of this example. The noise sensor 12C of this example has a coil pattern (antenna coil) 122 of plural turns as a conductor pattern on a flexible board 121 which may be a film-shaped insulator. Furthermore, according to the shape of the opening 43W, the coil pattern 122 is formed on the flexible board 121 with a size that allows part or all of this coil pattern 122 to face the inside of the shield member 43 from this opening 43W.

Furthermore, the flexible board 121 is attached to the outside surface of the shield member 43 (back side of the bottom surface) in the state in which part or all of the coil pattern 122 faces the inside of the shield member 43 from the opening 43W. Therefore, the opening 43W of the shield member 43 is sealed by the flexible board 121 of the noise sensor 12C. Accordingly, by this noise sensor 12C, noise that leaks externally through the opening 43W is alleviated.

One end 122a and the other end 122b of the coil pattern 122 of the noise sensor 12C are connected to the noise detecting circuit 13 in the internal circuit configuration of the position detecting device shown in FIG. 1 for example, as shown in FIG. 14.

As described above, in this example of FIG. 14, the opening 43W is made at part of the shield member 43 and the noise sensor 12C is stuck to the part of this opening 43W. This facilitates avoiding at least partially the noise blocking by the shield member 43 and facilitates noise detection by the noise sensor 12C.

In this case, the position in the shield member 43 of the noise sensor 12C, e.g., the position of the opening 43W, may be set to a position that facilitates efficient detection of the noise from the LCD panel 41 by the noise sensor 12C.

In a thin-film transistor (TFT) liquid crystal device for example, the LCD panel 41 may be configured as follows. As shown in FIG. 16, for liquid crystal cells 410 forming a respective one of vertical and horizontal plural pixels, field effect transistors (FETs; their diagrammatic representation is omitted) that drive a respective one of these liquid crystal cells 410 are disposed. Furthermore, in the TFT liquid crystal device, plural bus lines along the horizontal direction (gate electrode lines) 411 and plural bus lines along the vertical direction (source electrode lines) 412 are disposed. The gates of the FETs of plural liquid crystal cells on one row along the horizontal direction are connected to one gate electrode line 411 in common, and the sources of the FETs of plural liquid crystal cells on one column along the vertical direction are connected to one source electrode line 412 in common. An electrode and a capacitor of the liquid crystal cell 410 are connected to the drain of each FET.

For example, in a TFT liquid crystal device having pixels of 1,980×1,020 dots, the number of source electrode lines 412 is 1,980 and the number of gate electrode lines 411 is 1,020. Furthermore, in the TFT liquid crystal device, by voltage applied to the gate electrode line 411, all FETs of one row connected to the gate electrode line 411 are turned on and current flows between the source and the drain. In addition, each voltage applied to the source electrode line 412 at this time is applied to the liquid crystal electrode and a charge according to the voltage is accumulated in the capacitor.

The voltage application to the gate electrode line 411 is switched every one horizontal period by gate driver integrated circuits (ICs) 413. To each of the source electrode lines 412, a voltage according to the density of a respective one of the pixels is applied from a source driver IC 414. By the repetition of this, in the TFT liquid crystal device, an image is displayed on its display screen. In the example of FIG. 16, one gate driver IC 413 is provided per plural gate electrode lines 411. In addition, one source driver IC 414 is provided per plural source electrode lines 412.

The gate driver ICs 413 generate noise synchronizing with the horizontal synchronizing signal because switching the gate electrode line 411 every one horizontal period. Furthermore, the source driver ICs 414 also generate noise synchronizing with the horizontal synchronizing signal because operating to supply the voltage of a different pixel every one horizontal period.

Therefore, as parts where the noise from the LCD panel 41 is easily detected, the vicinity of the gate driver IC 413 or the source driver IC 414, an area that can include all or part of the gate electrode lines 411, an area that can include all or part of the source electrode lines 412, and so forth are conceivable. Therefore, the noise can be efficiently detected by making the opening 43W in the shield member 43 and disposing the noise sensor at these parts where the noise is easily detected.

The example of FIG. 14 is the case in which the opening 43W is made near one source driver IC 414 as shown by surrounding by a dotted line 43Wa in FIG. 16. As shown by surrounding by a dotted line 43Wb in FIG. 16, the opening 43W may be formed near one gate driver IC 413 and the noise sensor 12C may be positioned or stuck to the outside of the shield member 43 to seal this opening 43W.

The opening 43W may be formed to include not just the vicinity of one of the gate driver ICs 413 or the source driver ICs 414 but the vicinity of all gate driver ICs 413 or all source driver ICs 414, of course, or combinations thereof.

Furthermore, for example, in the case in which the peripheral part of the LCD panel 41 is fixed by a metal bezel, the gate driver ICs 413 and the source driver ICs 414 disposed around the LCD panel 41 are covered by the metal bezel. In this case, noise may be difficult to detect although the noise sensor is disposed near these gate driver ICs 413 or source driver ICs 414.

In such a case, as shown by a dotted line 43Wc in FIG. 16, the opening 43W may be made in the shield member 43 corresponding to an area including the whole of the plural gate electrode lines 411 and the noise sensor having a shape according to the opening 43W is disposed. This facilitates detection of noise in an embodiment. FIG. 15B shows an example of a noise sensor 12C′ provided for the opening 43W corresponding to the area including the whole of the plural gate electrode lines 411 as shown by the dotted line 43Wc.

Specifically, in the noise sensor 12C′ of FIG. 15B, a coil pattern 122′ is formed to cover the area including the whole of the plural gate electrode lines 411 and is formed of plural turns on a flexible board 121′ larger in size than or comparable to the opening 43W corresponding to the area including the whole of the plural gate electrode lines 411. Furthermore, one end 122a′ and the other end 122b′ of the coil pattern 122′ are connected to the noise detecting circuit 13. Also in this case, the coil pattern 122′ may be configured so that part or all of the pattern 122′ is exposed to the inside of the shield member 43 through the opening 43W.

It is also possible to detect noise by making the opening 43W in the shield member 43 correspond to the area including the whole of the plural source electrode lines 412 and disposing the noise sensor having a shape according to the opening 43W. Furthermore, it goes without saying that the position of the noise sensor is not limited to the above-described positions and an opening is made in the shield member 43 at the part where noise is generated from the LCD panel 41 most readily and the noise sensor is positioned or stuck to the shield member 43 at the position of the opening.

Furthermore, in the above-described example, the noise sensor is provided outside the bottom surface part of the shield member 43. However, by making an opening in the wall part around the bottom surface part of the shield member 43, the noise sensor may be provided on the wall part around the bottom surface part of this shield member 43.

Moreover, in the case of the noise sensor in which the flexible board 121 or 121′ and the coil pattern 122 or 122′ are made of transparent materials, the noise sensor may be disposed not on the back surface side of the LCD panel 41 or on the outside of the bottom surface of the shield member 43 but on the front surface of the LCD panel 41.

### DESCRIPTION OF REFERENCE SYMBOLS

11 Transparent sensor
12 Noise detecting electrode
13 Noise detecting circuit
14, 14a Pulse generating circuit
15 Phase control circuit
16 Stylus
17, 32 X selecting circuit
18, 33 Y selecting circuit
19 Switching circuit
20 Differential amplification circuit
21 Control circuit
22 Band-pass filter circuit
23 Switch
24 Detection circuit
25 AD conversion circuit
26 Microprocessor
27, 27a CPU
28, 29 AND gate
30, 31 Flip-flop
34 Transmitter
35 Amplification circuit
41 LCD panel
43 Shield member
43 W Opening
12C Noise sensor

1. A position detecting device that detects a position indicated by a finger or a stylus over a display device, the position detecting device comprising:
a noise sensor, which, in operation, generates indications of noise;
a noise detecting circuit, which, in operation, outputs noise detection signals based on indications of noise generated by the noise sensor;
a pulse generating circuit, which, in operation, generates pulses having a periodic cycle based on a periodic cycle of a synchronizing pulse of the display device;
phase control circuitry, which, in operation, controls a phase of the pulses generated by the pulse generating circuit to synchronize timing of the output of noise detection signals by the noise detecting circuit with timing of the pulses generated by the pulse generating circuit; and
a receiving circuit, which, in operation, receives position signals in synchronization with the timing of the pulses generated by the pulse generating circuit.

2. The position detecting device according to claim 1 wherein the phase control circuitry, in operation, controls the phase of the pulses generated by the pulse generating circuit to maintain a rate of occurrence of synchronization of the noise detection signals output by the noise detecting circuit with the pulses generated by the pulse generating circuit, which is equal to or higher than a threshold value.

3. The position detecting device according to claim 1 wherein the phase control circuitry, in operation:
generates control signals to apply a positive time shift to the pulses generated by the pulse generating circuit when a timing of the noise detection signals from the noise detecting circuit is earlier, by a difference within a threshold time, than a timing of the pulses output by the pulse generating circuit;
generates control signals to apply a negative time shift to the pulses generated by the pulse generating circuit when the timing of the noise detection signals from the noise detecting circuit is later, by a difference within the threshold time, than the timing of the pulses output by the pulse generating circuit;
adjusts the periodic cycle of the pulses generated by the pulse generating circuit to a shorter cycle when a rate of occurrence of the control signals to apply a positive time shift is higher than a rate of occurrence of the control signals to apply a negative time shift; and
adjusts the periodic cycle of the pulses generated by the pulse generating circuit to a longer cycle when the rate of occurrence of the control signals to apply a negative time shift is higher than the rate of occurrence of the control signals to apply a positive time shift.

4. The position detecting device according to claim 3 wherein the phase control circuitry, in operation:
generates control signals to apply a positive time shift to the pulses generated by the pulse generating circuit when the noise detection signals from the noise detecting circuit are output in a first half period of a synchronization period of the noise detection signals and the pulses generated by the pulse generating circuit; and
generates control signals to apply a negative time shift to the pulses generated by the pulse generating circuit when the noise detection signals from the noise detecting circuit are output in a second half period of the synchronization period of the noise detection signals and the pulses generated by the pulse generating circuit.

5. The position detecting device according to claim 3 wherein,
the pulse generating circuit, in operation, generates pulses having a same time width as a synchronization time period of the noise detection signals and the pulses generated by the pulse generating circuit; and
the phase control circuitry, in operation, generates control signals to apply a positive time shift to the pulses generated by the pulse generating circuit when the noise detection signals from the noise detecting circuit coincide with a rising edge of a pulse output by the pulse generating circuit, and generates control signals to apply a negative time shift to the pulses generated by the pulse generating circuit when the noise detection signals from the noise detecting circuit coincide with a falling edge of the pulse output by the pulse generating circuit.

6. The position detecting device according to claim 1 wherein,
the display device and a drive circuit of the display device are covered by a shield member; and
the noise sensor is positioned outside the shield member, and, in operation, detects noise through an opening in the shield member.

7. The position detecting device according to claim 6 wherein,
the opening is positioned around the drive circuit of the display device; and
the noise sensor, in operation, detects noise from the drive circuit of the display device.

8. The position detecting device according to claim 6 wherein,
a position of the opening corresponds to a position of an area including all or part of electrode lines along horizontal direction or vertical direction of the display device; and
the noise sensor, in operation, detects noise from the electrode lines of the display device.

9. The position detecting device of claim 1 wherein the noise detecting circuit, in operation, outputs a noise detection signal in response to an indication of noise above a threshold noise detection level.

10. A method of detecting a position indicated by a finger or a stylus over a display device, the method comprising:
sensing, using a sensor of the display device, noise associated with the detecting of the indicated position;
generating noise detection signals based on the sensing;
generating pulses having a periodic cycle based on a periodic cycle of a synchronizing pulse of the display device;
controlling a phase of the generated pulses to synchronize timing of the noise detection signals with timing of the generated pulses; and
receiving position signals in synchronization with the timing of the generated pulses.

11. The method of claim 10, comprising:
controlling the phase of the generated pulses to maintain a rate of occurrence of synchronization of the noise detection signals with the generated pulses which is equal to or higher than a threshold value.

12. The method of claim 11, comprising:
generating control signals to apply a positive time shift to the generated pulses when a timing of the noise detection signals is earlier, by a difference within a threshold time, than a timing of the generated pulses;
generating control signals to apply a negative time shift to the generated pulses when the timing of the noise detection signals is later, by a difference within the threshold time, than the timing of the generated pulses;
adjusting the periodic cycle of the generated pulses to a shorter cycle when a rate of occurrence of the control signals to apply a positive time shift is higher than a rate of occurrence of the control signals to apply a negative time shift; and
adjusting the periodic cycle of the generated pulses to a longer cycle when the rate of occurrence of the control signals to apply a negative time shift is higher than the rate of occurrence of the control signals to apply a positive time shift.

13. The method of claim 12, comprising:
generating control signals to apply a positive time shift to the generated pulses when the noise detection signals occur during a first half period of a synchronization period of the noise detection signals and the generated pulses; and
generating control signals to apply a negative time shift to the generated pulses when the noise detection signals occur during a second half period of the synchronization period of the noise detection signals and the generated pulses.

14. The method of claim 12, comprising:
generating a pulse having a time width of a synchronization time window of the noise detection signals;
generating control signals to apply a positive time shift to generated pulses when the noise detection signals coincide with a rising edge of the generated pulse; and
generating control signals to apply a negative time shift to generated pulses when the noise detection signals coincide with a falling edge of the generated pulse.

15. The method of claim 10, comprising:
shielding the display device using a shield, wherein the sensing noise comprises sensing noise an opening in the shield.

16. The method of claim 10 wherein the sensing comprises sensing noise from a drive circuit of the display device.

17. A system, comprising:
display circuitry, which, in operation, generates a display synchronization signal; and
position detection circuitry, which, in operation:
senses noise associated with detecting of position information;
generates noise detection signals based on the sensing;
generates noise synchronization pulses having a periodic cycle associated with a periodic cycle of the display synchronizing signal;
controls a phase of the generated noise synchronization pulses to synchronize timing of the noise detection signals with timing of the generated noise synchronization pulses; and
receives signals associated with the detecting of position information in synchronization with the timing of the generated noise synchronization pulses.

18. The system of claim 17 wherein the position detection circuitry, in operation:
generates control signals to apply a positive time shift to the generated noise synchronization pulses when a timing of the noise detection signals is earlier, by a difference within a threshold time, than a timing of the generated noise synchronization pulses;
generates control signals to apply a negative time shift to the generated noise synchronization pulses when the timing of the noise detection signals is later, by a difference within the threshold time, than the timing of the generated noise synchronization pulses;
adjusts the periodic cycle of the generated noise synchronization pulses to a shorter cycle when a rate of occurrence of the control signals to apply a positive time shift is higher than a rate of occurrence of the control signals to apply a negative time shift; and
adjusts the periodic cycle of the generated noise synchronization pulses to a longer cycle when the rate of occurrence of the control signals to apply a negative time shift is higher than the rate of occurrence of the control signals to apply a positive time shift.

19. The system of claim 17, comprising:
a stylus, which, in operation, indicates a position over the display circuitry.
